(19) United States
(12) Patent Application Publication
(10) Pub. No.: US 2020/0145194 A1
(43) Pub. Date: May 7, 2020

(54) BLOCKCHAIN INFRASTRUCTURE SOLUTIONS

(71) Applicant: Michael Alan Stollery, North Hollywood, CA (US)

(72) Inventor: Michael Alan Stollery, North Hollywood, CA (US)

(21) Appl. No.: 16/409,490

(22) Filed: May 10, 2019

Related U.S. Application Data
(60) Provisional application No. 62/670,556, filed on May 11, 2018.

(51) Int. Cl. H04L 9/06; G06Q 20/36; H04L 9/00; H04L 29/12

(52) U.S. Cl. CPC H04L 9/0637; G06Q 20/36; H04L 2209/56; H04L 61/1511; H04L 2209/38; H04L 9/006

(57) ABSTRACT

The disclosed methods include combining wallet functionality with smart contract protocols, adding sub-blockchain(s) to a blockchain to improve transaction volume at greater transaction completion speed, domain name system routing on a blockchain, and associating a private-public key pair to a device for discovery and identification.

### CROSS-REFERENCE TO RELATED APPLICATIONS

This application claims priority to U.S. Provisional Application No. 62/670,556, entitled “BLOCKCHAIN INFRASTRUCTURE SOLUTIONS,” and filed May 11, 2018, which is incorporated by reference herein in its entirety.

### TECHNICAL FIELD

The disclosed teachings relate to blockchain infrastructure solutions.

### BACKGROUND

A blockchain is an open, decentralized ledger that can record transactions between multiple parties in a verifiable and permanent way. Specifically, a blockchain is a decentralized database on a distributed computing system that maintains a continuously growing list of ordered records called blocks. Each block contains a timestamp and a link to a previous block. Blockchains are inherently resistant to modification of their recorded data. Once recorded, the data in a block cannot be altered retroactively. A blockchain database is managed autonomously through the use of a peer-to-peer network and distributed time-stamping.

Decentralized consensus can be achieved with a blockchain. This makes blockchains suitable for recording events, medical records, and other records management activities, identity management, transaction processing, and proving data provenance. Well known examples of decentralized systems that implement blockchains include Bitcoin and Ethereum cryptocurrency systems. These types of systems provide a pragmatic solution for arriving at a consensus in the face of trust and timing problems typically encountered in distributed networks.

### BRIEF DESCRIPTION OF THE DRAWINGS

FIG. 1 is a block diagram that illustrates a distributed computing system for a blockchain according to some embodiments of the present disclosure;

FIG. 2 illustrates a representation of a blockchain and sub-blockchain according to some embodiments of the present disclosure;

FIG. 3 illustrates a representation of DNS on a blockchain according to some embodiments of the present disclosure;

FIG. 4 is a flowchart that illustrates a representation of a smart contract with wallet functionality according to some embodiments of the present disclosure;

FIG. 5 is a flowchart that illustrates a representation of device public-private keys on a network according to some embodiments of the present disclosure; and

FIG. 6 is a block diagram that illustrates a computer operable to implement the disclosed technology according to some embodiments of the present disclosure.

### DETAILED DESCRIPTION

The embodiments set forth below represent the necessary information to enable those skilled in the art to practice the embodiments, and illustrate the best mode of practicing the embodiments. Upon reading the following description in light of the accompanying figures, those skilled in the art will understand the concepts of the disclosure and will recognize applications of these concepts that are not particularly addressed here. It should be understood that these concepts and applications fall within the scope of the disclosure and the accompanying embodiments.

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, the terms “connected,” “coupled,” or variants thereof, refer to any connection or coupling, either direct or indirect, between two or more elements. The coupling or connection between the elements can be physical, logical, or a combination thereof.

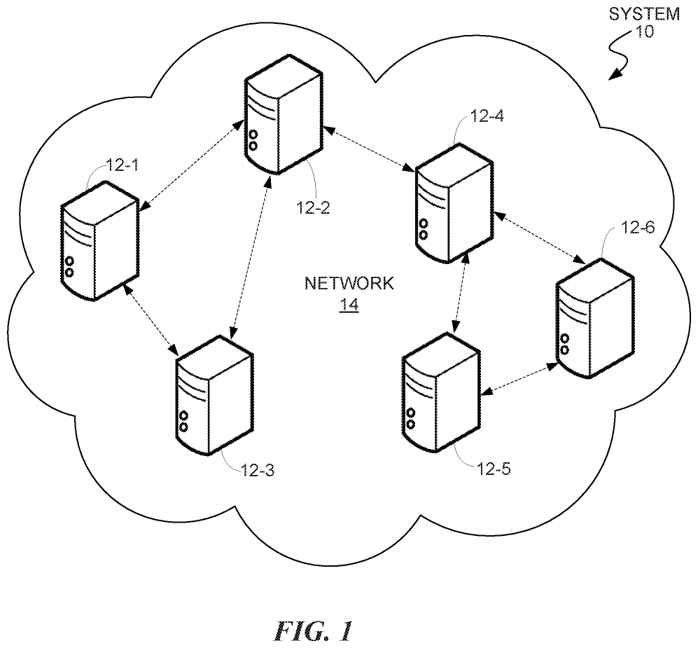

FIG. 1 illustrates a system 10 that includes a network 14 of interconnected peer nodes 12 according to some embodiments of the present disclosure. The peer nodes 12 may be distributed across various geographic locations including regions all over the world. The embodiments may implement services on the peer nodes 12, which can perform processes of the blockchain. The network 14 may include a combination of private, public, wired, or wireless portions. Data communicated over the network 14 may be encrypted or unencrypted at various locations or portions of the network 14. Each peer node 12 may include combinations of hardware and/or software to process data, perform functions, communicate over the network 14, and the like.

The peer nodes 12 may include computing devices such as servers, desktop or laptop computers (e.g., Apple MacBook, Lenovo 440), handheld mobile devices (e.g., Apple iPhone, Samsung Galaxy, Microsoft Surface), and any other electronic computing device. Any component of the network 14 may include a processor, memory or storage, a network transceiver, a display, operating system and application software (e.g., for providing a user interface), and the like. Other components, hardware, and/or software included in the network 14 that are well known to persons skilled in the art are not shown or discussed herein for brevity.

The network 14 may utilize cryptography to securely process transactions over the network 14. For example, public-key cryptography uses asymmetric key algorithms, where a key used by one party to perform either encryption or decryption is not the same as the key used by another in the counterpart operation. Each party has a pair of cryptographic keys: a public encryption key and a private decryption key. For example, a key pair used for digital signatures consists of a private signing key and a public verification key. The public key may be widely distributed, while the private key is known only to its proprietor. The keys are related mathematically, but the parameters are chosen so that calculating the private key from the public key is unfeasible. Moreover, the keys could be expressed in various formats, including hexadecimal format.

Blockchain with Linked Sub Blockchains

A blockchain is a continuously growing list of records (called “blocks”), which are linked and secured using cryptographic means. Each block usually contains a cryptographic hash of the previous block, a timestamp of the transaction and the transaction data. Each block is immutable and the data in the block is ‘open’ for open ledger blockchains or closed for private ledger blockchains. That is, once the block is recorded, it cannot be changed without retroactively changing all future and previous blocks. As a blockchain grows, it takes increasingly more resources and time to add new blocks to the chain.

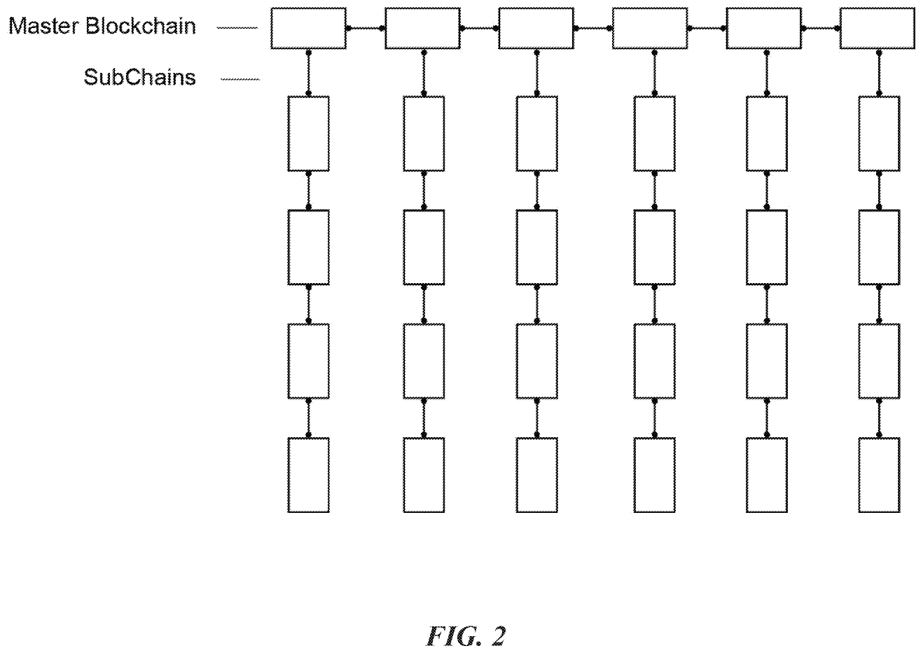

The disclosed embodiments overcome these drawbacks by adding sub blockchains, which allow for more transaction volume at greater transaction completion speed. A sub-blockchain may have the following features: (i) block type able to be the same or different from the master chain: block size, hashing algorithm, block timing, and proof of work or proof of stake or alternate proof of block acceptance; (ii) name reservation (e.g., sub-chains can be referred to by either address or ICAAN style name); (iii) interactions with other sub-chains can be available via atomic swaps (e.g., a pure swap from one token to another of differing value at the appropriate rate); (iv) sub-chain smart contracts can control atomic swaps between other chains; and/or (v) fees for sub-chain and intra-sub-chain transactions will filter up to the master chain. The master chain can have the ability to receive fees through the sub-chain creation contract, and fees for sub-chains are able to be in the sub-chain currency based on varying factors. FIG. 2 illustrates a representation of a blockchain and sub-blockchain according to some embodiments of the present disclosure.

Domain Name System Routing on a Blockchain

Domain Name System (DNS) routing is currently a decentralized, hierarchical naming system for computers, services, or other resources connected to the Internet. Even though the current system is decentralized, it is still possible for a hacker to redirect DNS traffic to a compromised server. On Apr. 24, 2018, the MyEtherWallet traffic was hijacked by a Border Gateway Protocol route hijack. While the MyEtherWallet system itself was not hacked, the hijacked DNS routing diverted users to a compromised server that allowed hackers to transfer wallet contents.

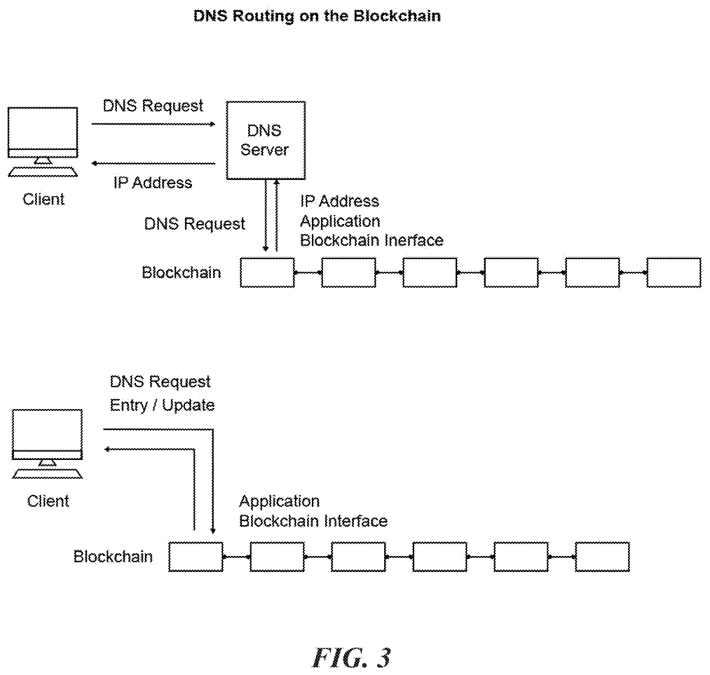

The disclosed embodiments overcome these drawbacks by including DNS routing on a blockchain, which will add routing information to an immutable block. Updates to routing information stored on the blockchain would require consensus, which avoids the risk of protocol route hijacking. Routing traffic by blockchain addresses ensures that routes cannot be hijacked or changed. Routing internet traffic in this manner guarantees logging reliability. Routing can be guaranteed to be consistent and immutable through smart contracts and public or private blockchain addressing. FIG. 3 illustrates a representation of DNS on a blockchain according to some embodiments of the present disclosure.

Wallet Using Smart Contract Translations

The disclosed embodiments include a blockchain (also referred to as or including crypto, digital currency, altcoin, token) wallet using smart contract translations for, among other things, peer-to-peer transfers, multi-signature configuration, security purposes, speed of transfers, multiple transactions, centralized or decentralized purchases, multiple factor authentication, hard-wallet, cold storage, paper wallet, encryption, and or software wallet purposes, identity verification, and/or theft/hack protection.

A smart contract is a computer protocol intended to facilitate, verify, and/or enforce the execution of a contract via digital currency. A smart contract will allow the execution of transactions without third parties but is not necessarily exclusive to two parties. Execution depends on logic programmed into its protocol.

A blockchain wallet is a hardware or software structure that stores public and private keys (e.g., encrypted) that can be used to receive or send one or more digital currencies (e.g., altcoins, cryptocurrency, and/or tokens). Cryptocurrency might be received in a wallet from a hardware or software source (e.g., hard wallet, paper wallet, or exchange address) via public wallets public address. The owner(s) one or more wallets, with access to corresponding private key(s), May choose to send digital currency to another wallet, exchange, website and/or multiple external sources.

Adding wallet (e.g., hard, soft, and/or paper) functionality to a smart contract provides, but is not limited to, distribution of digital currency(ies). A combination of smart contract programming, protocol, and intent solves many of the security issues to which current wallet models are prone. Using smart contracts to generate a wallet and access all wallet functions on any blockchain type. Smart contract(s) may, but are not bound to, regulate when, how much, and by whom digital currency might be exchanged between one or more sources such as, for example, wallets, websites, individuals, exchanges, addresses, etc.

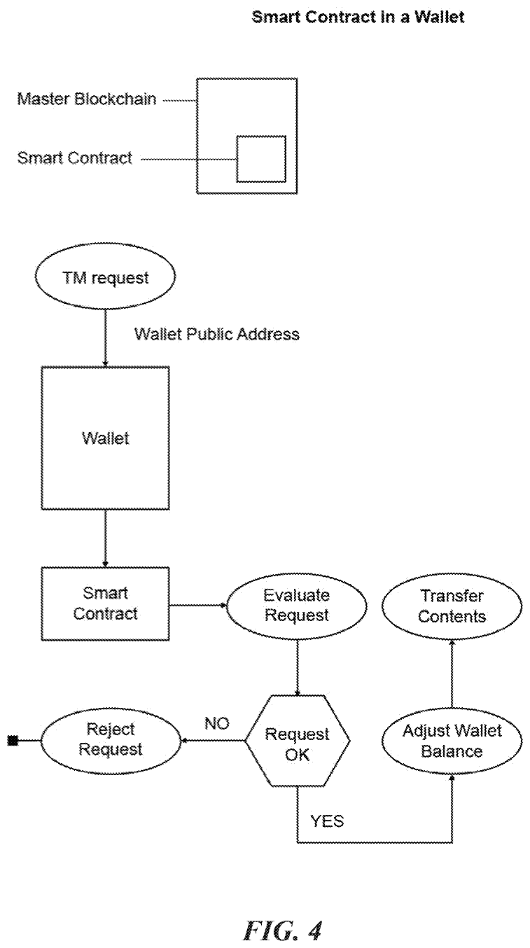

Multiple party consent may be required to use functions of the wallet controlled through the smart contract. FIG. 4 is a flowchart that illustrates a representation of a smart contract with wallet functionality according to some embodiments of the present disclosure.

Public-Private Key Device Identification

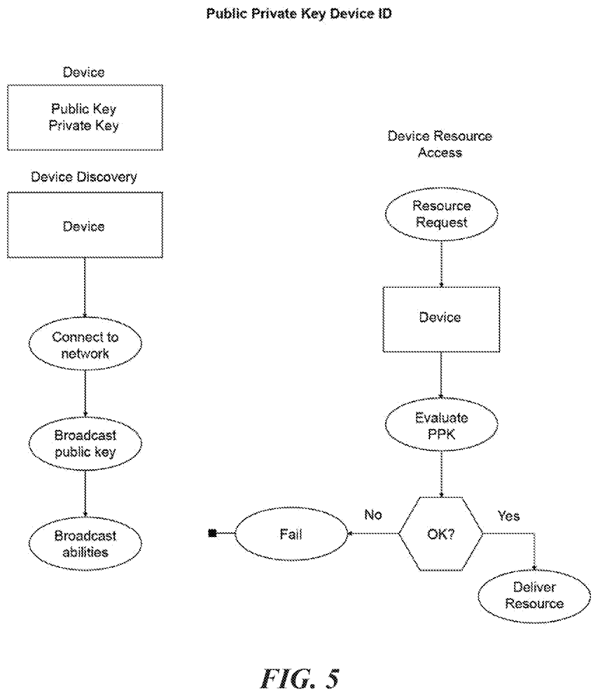

The disclosed embodiments include a public-private key (PPK) device ID, which may include a system that will associate a device with both a public key and private key. The public key will allow for device discovery and identification on a network. Device manipulation may only be possible with access to the device private key. A device PPK pair will allow device owners to securely share device resources on a network without the risk of device compromise. Through blockchain addressing a specific device or multiple devices may be identified by their specific addresses, this includes both wallet and smart contract addresses. FIG. 5 is a flowchart that illustrates a representation of device public-private keys on a network according to some embodiments of the present disclosure.

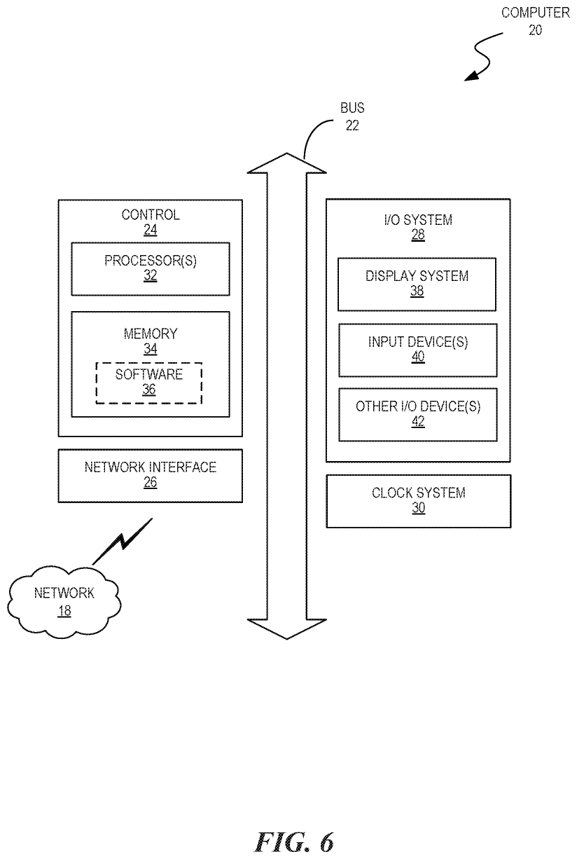

FIG. 6 is a block diagram of a computer 20 of system 10 operable to implement the disclosed technology according to some embodiments of the present disclosure. The computer 20 may be a generic computer or specifically designed to carry out features of system 10. For example, the computer 20 may be a system-on-chip (SOC), a single-board computer (SBC) system, a desktop or laptop computer, a kiosk, a mainframe, a mesh of computer systems, a handheld mobile device, or combinations thereof.

The computer 20 may be a standalone device or part of a distributed system that spans multiple networks, locations, machines, or combinations thereof. In some embodiments, the computer 20 operates as a server computer (e.g., node 12) or a client device in a client-server network environment, or as a peer machine in a peer-to-peer system. In some embodiments, the computer 20 may perform one or more steps of the disclosed embodiments in real time, in near real time, offline, by batch processing, or combinations thereof.

As shown, the computer 20 includes a bus 22 operable to transfer data between hardware components. These components include a control 24 (i.e., processing system), a network interface 26, an Input/Output (I/O) system 28, and a clock system 30. The computer 20 may include other components not shown or further discussed for the sake of brevity. One having ordinary skill in the art will understand any hardware and software included but not shown in FIG. 6.

The control 24 includes one or more processors 32 (e.g., Central Processing Units (CPUs), Application Specific Integrated Circuits (ASICs), and/or Field Programmable Gate Arrays (FPGAs)) and memory 34 (which may include software 36). The memory 34 may include, for example, volatile memory such as random-access memory (RAM) and/or non-volatile memory such as read-only memory (ROM). The memory 34 can be local, remote, or distributed.

A software program (e.g., software 36), when referred to as “implemented in a computer-readable storage medium,” includes computer-readable instructions stored in a memory (e.g., memory 34). A processor (e.g., processor 32) is “configured to execute a software program” when at least one value associated with the software program is stored in a register that is readable by the processor. In some embodiments, routines executed to implement the disclosed embodiments may be implemented as part of operating system (OS) software (e.g., Microsoft Windows®, Linux®) or a specific software application, component, program, object, module or sequence of instructions referred to as “computer programs.”

As such, the computer programs typically comprise one or more instructions set at various times in various memory devices of a computer (e.g., computer 20) and which, when read and executed by at least one processor (e.g., processor 32), cause the computer to perform operations to execute features involving the various aspects of the disclosed embodiments. In some embodiments, a carrier containing the aforementioned computer program product is provided. The carrier is one of an electronic signal, an optical signal, a radio signal, or a non-transitory computer-readable storage medium (e.g., the memory 34).

The network interface 26 may include a modem or other interfaces (not shown) for coupling the computer 20 to other computers over the network 18. The I/O system 28 may operate to control various I/O devices, including peripheral devices such as a display system 38 (e.g., a monitor or touch-sensitive display) and one or more input devices 40 (e.g., a keyboard and/or pointing device). Other I/O devices 42 may include, for example, a disk drive, printer, scanner, or the like. Lastly, the clock system 30 controls a timer for use by the disclosed embodiments.

Operation of a memory device (e.g., memory 34), such as a change in state from a binary one to a binary zero (or vice versa) may comprise a visually perceptible physical transformation. The transformation may comprise a physical transformation of an article to a different state or thing. For example, a change in state may involve accumulation and storage of charge or release of stored charge. Likewise, a change of state may comprise a physical change or transformation in magnetic orientation, or a physical change or transformation in molecular structure, such as from crystalline to amorphous or vice versa.

Aspects of the disclosed embodiments may be described in terms of algorithms and symbolic representations of operations on data bits stored on memory. These algorithmic descriptions and symbolic representations generally include a sequence of operations leading to a desired result. The operations require physical manipulations of physical quantities. Usually, though not necessarily, these quantities take the form of electrical or magnetic signals capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computers, those skilled in the art will appreciate that the various embodiments are capable of being distributed as a program product in a variety of forms and that the disclosure applies equally regardless of the particular type of machine or computer-readable media used to actually effect the embodiments.

While the disclosure has been described in terms of several embodiments, those skilled in the art will recognize that the disclosure is not limited to the embodiments described herein and can be practiced with modifications and alterations within the spirit and scope of the invention. Those skilled in the art will also recognize improvements to the embodiments of the present disclosure. All such improvements are considered within the scope of the concepts disclosed herein. Thus, the description is to be regarded as illustrative instead of limiting.

1. A method comprising:
combining wallet functionality with smart contract protocols; and
distributing digital currencies based on the combination of the wallet functionality with smart contract protocols.

2. A method comprising:
generating a blockchain; and
adding one or more sub-blockchains to the generated blockchain to improve transaction volume at greater transaction completion speed.

3. A method comprising:
domain name system (DNS) routing on the blockchain that adds routing information to an immutable block of the blockchain; and
updating routing information stored on the blockchain that requires consensus, which avoids a risk of protocol route hijacking.

4. A method comprising:
associating a public-private key pair with a computing device; and
enabling discovery and identification of the computing device with the public-private key pair.
